(19) United States
(12) Patent Application Publication
(10) Pub. No.: US 2005/0264750 A1
(43) Pub. Date: Dec. 1, 2005

(54) Liquid crystal display apparatus with highly uniform substrate gap

(75) Inventor: Shinya Andoh, Tokyo (JP)

Correspondence Address: FRISHAUF, HOLTZ, GOODMAN & CHICK, PC, 220 5TH AVE FL 16, NEW YORK, NY, 10001-7708, US

(73) Assignee: Casio Computer Co., Ltd., Tokyo (JP)

(21) Appl. No.: 11/141,667

(22) Filed: May 31, 2005

(30) Foreign Application Priority Data
Jun. 1, 2004 (JP) 2004-162761

(51) Int. Cl. G02F 1/1339

(52) U.S. Cl. 349/156

(57) ABSTRACT

A liquid crystal display apparatus has a first substrate; a second substrate facing the first substrate; a sealant provided between the first substrate and the second substrate; a liquid crystal filled in space formed by the first substrate, the second substrate and the sealant; and columnar spacers provided between the first substrate inward of the sealant and the second substrate, whereby a distribution density of those columnar spacers which are located in a neighborhood of the sealant is higher than a distribution density of those columnar spacers which are located inward of the sealant.

### BACKGROUND OF THE INVENTION

1. Field of the Invention

The present invention relates to a liquid crystal display apparatus, and, more particularly, to a liquid crystal display apparatus with a highly uniform substrate gap.

2. Description of the Related Art

The conventional liquid crystal display apparatus that is described in Unexamined Japanese Patent Application KOKAI Publication No. 2003-15137 comprises two substrates of glass or the like adhered via a sealant with a nearly quadrate frame shape, columnar spacers, which are formed of a resin and restrict a gap between the substrates inward of the sealant, and a liquid crystal sealed between the substrates inward of the sealant. The columnar spacers of the liquid crystal display apparatus are laid out between both substrates inward of the sealant at a uniform distribution pitch.

The two substrates of the conventional liquid crystal display apparatus are adhered in the following procedures. First, a thermosetting resin is applied to the top surface of one of the substrates by a dispenser, thereby forming a sealant. Next, the two substrates are placed one on the other with the sealant in between, are pressed by a pressing jig, and are heated in that state, thereby curing the sealant.

The conventional liquid crystal display apparatus however has no columnar spacers provided in a region where the sealant is laid out. With the distribution pitch of columnar spacers being one columnar spacer per pixel, for example, the distribution density of the columnar spacers in the inner neighborhood of the sealant including the sealant laid-out region becomes extremely lower than the distribution density of the columnar spacers in a region inward of the inner neighborhood of the sealant.

As a result, when the sealant is cured by pressure and heating, the pressure applied on each of the columnar spacers located in the inner neighborhood of the sealant becomes higher than the pressure applied on each of the columnar spacers located in a region inward of the inner neighborhood. Therefore, the columnar spacers located in the inner neighborhood of the sealant are crushed more than the columnar spacers located in the region inward of the inner neighborhood. As the substrate gap in the inner neighborhood of the sealant becomes narrower than the substrate gap in the region inward of the inner neighborhood, a non-uniform substrate gap is produced in the inner neighborhood of the sealant, lowering the display quality. A similar problem occurs when columnar spacers for restricting the substrate gap are intervened between both substrates outward of the sealant at the same distribution pitch as that of the columnar spacers provided between both substrates inward of the sealant.

### SUMMARY OF THE INVENTION

Accordingly, it is an object of the invention to provide a liquid crystal display apparatus which makes a non-uniform substrate gap from being produced in an inner neighborhood of a sealant.

To achieve the object, a liquid crystal display apparatus according to one aspect of the invention comprises a first substrate; a second substrate facing the first substrate; a sealant provided between the first substrate and the second substrate; a liquid crystal filled in space formed by the first substrate, the second substrate and the sealant; and columnar spacers provided between the first substrate inward of the sealant and the second substrate, whereby a distribution density of those columnar spacers which are located in a neighborhood of the sealant is higher than a distribution density of those columnar spacers which are located inward of the sealant.

### BRIEF DESCRIPTION OF THE DRAWINGS

These objects and other objects and advantages of the present invention will become more apparent upon reading of the following detailed description and the accompanying drawings in which:

FIG. 1 is a plan view of a liquid crystal display apparatus according to one embodiment of the invention;

FIG. 2 is a partly cutaway plan view of a part of a sealant inner center region;

FIG. 3 is a partly cutaway plan view of a part of a sealant inner neighborhood region;

FIG. 4 is an enlarged cross-sectional view along line IV-IV in FIG. 2; and

FIG. 5 is a diagram showing the relationship between the distribution density of columnar spacers and a substrate gap.

### DETAILED DESCRIPTION OF THE PREFERRED EMBODIMENT

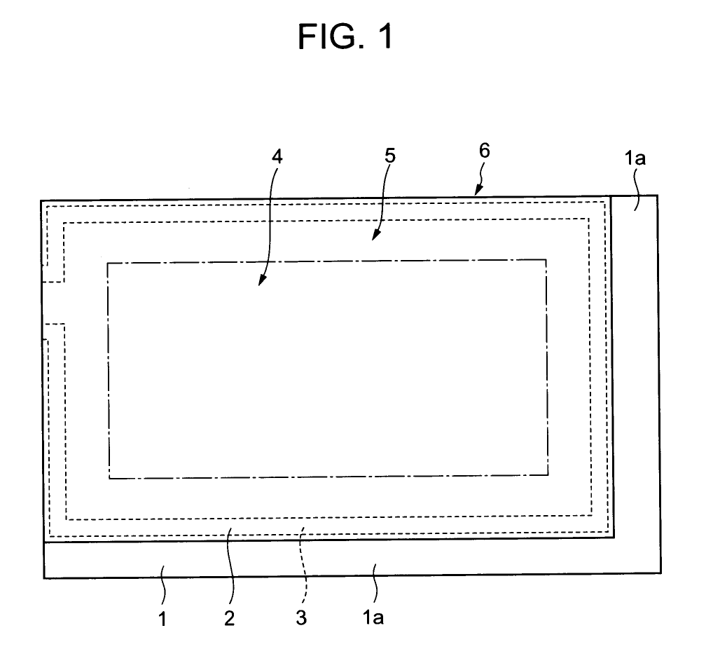

FIG. 1 presents a plan view of a liquid crystal display apparatus according to one embodiment of the invention. The liquid crystal display apparatus is, for example, an active matrix type color liquid crystal display apparatus having thin film transistors as switching elements. As shown in a plan view in FIG. 1, the liquid crystal display apparatus comprises an active substrate 1 of glass or the like, an opposing substrate 2 of glass or the like, and a sealant 3. The opposing substrate 2 is adhered, overlaid, onto the active substrate 1 with the sealant 3 having a nearly quadrate frame shape in between. A liquid crystal is sealed between the active substrate 1 and the opposing substrate 2 inward of the sealant 3.

In the present specification, a quadrate region in the center portion inward of the sealant 3 shown in FIG. 1, surrounded by an alternate dash and dot line, is called “sealant inner center region 4”. A region held between the sealant 3 and a region outward of the sealant inner center region 4 is called “sealant inner neighborhood region 5”, and a region outward of the sealant 3 where both substrates 1 and 2 overlie each other is called “sealant outer region 6”. The active substrate 1 has a protrusion part 1a comprised of two adjacent sides of the active substrate 1 and protruding from the opposing substrate 2. Connection terminals (not shown) and the like are provided on the top surface of the protrusion part 1a.

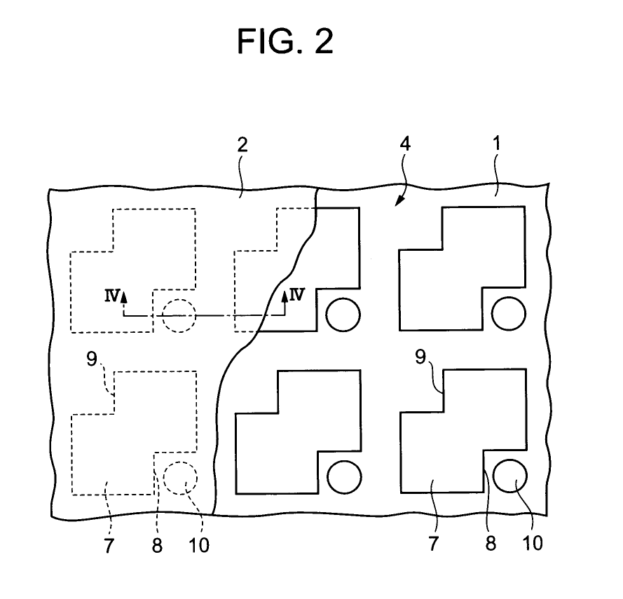

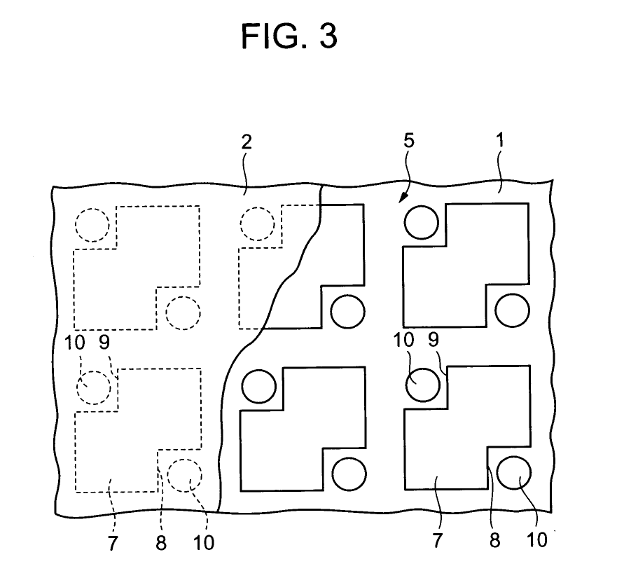

FIG. 2 presents a partly cutaway plan view of the sealant inner center region 4, and FIG. 3 presents a partly cutaway plan view of the sealant inner neighborhood region 5. Pixel electrodes 7 are laid out in a matrix form on the top surface of the active substrate 1 (the opposing side of the opposing substrate 2) inward of the sealant 3, i.e., at the sealant inner center region 4 and the sealant inner neighborhood region 5. In this case, the pixel electrode 7 has square cutaway portions 8 and 9 at the lower right and upper left corners of the square shape of the pixel electrode 7.

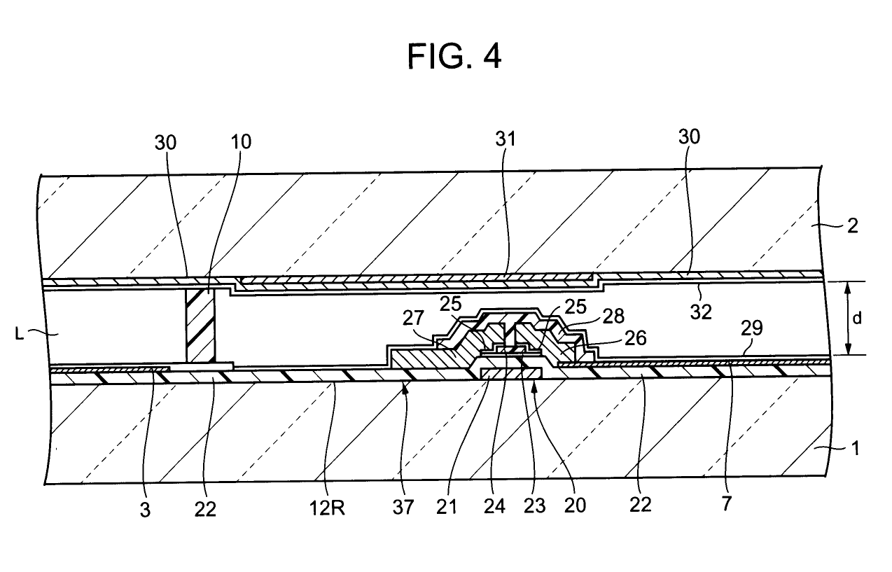

FIG. 4 is a cross-sectional view along line IV-IV in FIG. 2. Thin film transistors (TFTs) 20 are formed on the active substrate 1 in association with the pixel electrodes 7. The TFT 20 comprises a gate electrode 21, a gate insulating layer 22, a semiconductor layer 23, a semiconductor protection film 24, contact layers 25, a source electrode 26, a drain electrode 27, an overcoat film 28, and an alignment film 29.

The gate electrode 21 is formed on the active substrate 1. The gate insulating layer 22 is formed on the entire inner surface of the active substrate 1 and the gate electrode 21. The pixel electrode 7 of a transparent conductive material, such as ITO (Indium Tin Oxide), connected to the source electrode 26 of the TFT 20 is provided on the gate insulating layer 22. The semiconductor layer 23 is formed at a region corresponding to the gate electrode 21 on the gate insulating layer 22. The semiconductor protection film 24, which is formed at the center portion of the semiconductor layer 23, serves as a protection film against etching. Each contact layer 25 comprises n+a-Si (amorphous silicon doped with an N-type impurity), and is formed extending from the top surface of the semiconductor layer 23 on one end side to a part of the semiconductor protection film 24. The source electrode 26 is formed on one of the contact layers 25. The drain electrode 27 is formed on the other contact layer 25. The overcoat film 28 is formed on the source electrode 26 and the drain electrode 27 of the TFT 20. The alignment film 29 is formed on the pixel electrode 7, the overcoat film 28 and the gate insulating layer 22.

A light shielding film 31 is provided at a region corresponding to the TFT 20. A common electrode 30 of a transparent conductive material, such as ITO, is provided on the light shielding film 31 and one side of the opposing substrate 2. An alignment film 32 is formed on one side of the common electrode 30. An alignment process is performed in such a way that the alignment direction of the alignment film 32 differs from the alignment direction of the alignment film 29 provided on the active substrate 1 by 90 degrees.

Columnar spacers 10 are provided between the alignment film 29 provided on the active substrate 1 and the alignment film 32 provided on the opposing substrate 2. Each columnar spacer 10 is formed of a resin material by the printing scheme, the transfer scheme or the like. The columnar spacers 10 are provided to accurately set a gap d between the active substrate 1 and the opposing substrate 2. A liquid crystal L is filled in the gap d between the active substrate 1 and the opposing substrate 2, which is provided by the columnar spacers 10.

In the sealant inner center region 4, as shown in FIG. 2, the circular columnar spacer 10 is laid out at the cutaway portion 8 at the lower right corner of each pixel electrode 7. In the sealant inner neighborhood region 5, as shown in FIG. 3, the circular columnar spacers 10 of a resin are likewise laid out at both cutaway portions 8 and 9 of each pixel electrode 7. Therefore, the distribution density of the columnar spacers 10 (the quantity of the columnar spacers per pixel) is one columnar spacer for a single pixel electrode 7 (one pixel) in the sealant inner center region 4 shown in FIG. 2, and two columnar spacers per pixel electrode 7 in the sealant inner neighborhood region 5 shown in FIG. 3.

As two columnar spacers 10 per pixel electrode 7 are laid out in the sealant inner neighborhood region 5 and one columnar spacer 10 per pixel electrode 7 is laid out in the sealant inner center region 4, the distribution density of the columnar spacers 10 in the sealant inner neighborhood region 5 can be increased. As a result, the pressure applied to each of the columnar spacers 10 located in the sealant inner neighborhood region 5 becomes approximately the same as the pressure applied to each of the columnar spacers 10 located in the sealant inner center region 4 when the sealant 3 of a thermosetting resin is cured by pressure and heating. In other words, the columnar spacers 10 located in the sealant inner neighborhood region 5 are crushed in approximately the same way as the columnar spacers 10 located in the sealant inner center region 4. This can make it difficult to produce a non-uniform substrate gap in the sealant inner neighborhood region 5, so that the substrate gap in the entire inward region of the sealant 3 can be made more uniform.

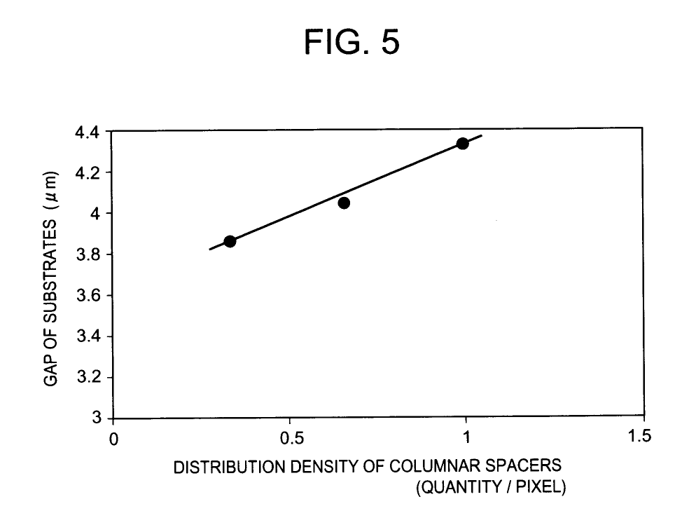

FIG. 5 shows the result of studying the relationship between the distribution density of the columnar spacers 10 (quantity per pixel) and the gap of substrates. As apparent from FIG. 5, the distribution density of the columnar spacers 10 is nearly proportional to the substrate gap, so that as the distribution density of the columnar spacers 10 increases, the substrate gap increases. To suppress the substrate gap in the sealant inner neighborhood region 5 from becoming smaller than a given value, therefore, the distribution density of the columnar spacers 10 in the sealant inner neighborhood region 5 should be set adequately greater than the distribution density of the columnar spacers 10 in the sealant inner center region 4.

According to the invention, as apparent from the above, the substrate gap in the entire inward region of the sealant 3 can be made more uniform by adjusting the distribution density of the columnar spacers 10.

The invention is not limited to the embodiment discussed above, but can be modified and adapted in various forms.

For example, although the columnar spacer 10 is provided at the cutaway portion 9 at the upper right corner of the pixel electrode 7 in FIG. 3, the columnar spacer 10 can be laid out for every other pixel electrode 7 or every two or more pixel electrodes 7. The columnar spacer 10 may be laid out for every other pixel electrode 7 or every two or more pixel electrodes 7 in the column direction, or may be laid out for every other pixel electrode 7 or every two or more pixel electrodes 7 in the row direction. Any distribution can be taken as long as the distribution density of the columnar spacers 10 in the sealant inner neighborhood region 5 is adequately higher than the distribution density of the columnar spacers 10 in the sealant inner center region 4.

Although the foregoing description of the embodiment has been given of a structural example where the columnar spacers 10 are not laid out in the sealant outer region 6, the invention is not limited to this example, but can take such a structure that columnar spacers are laid out in the sealant outer region 6. For instance, columnar spacers may be formed in the sealant outer region 6 at a higher distribution density than the columnar spacers in the sealant inner neighborhood region 5. When the pressure applied to the sealant inner neighborhood region 5 is about the same as the pressure applied to the sealant outer region 6, in particular, columnar spacers should be provided in the sealant outer region 6 at approximately the same distribution density as the distribution density of the columnar spacers 10 in the sealant inner neighborhood region 5. Specifically, the width of the sealant 3 is 2 mm or so, and the width of the sealant outer region 6 is 0.5 mm or so.

When the distribution pitch of pixels is 30/mm, the width of the sealant outer region 6 (0.5 mm or so) is wide enough to arrange 15 pixels. Therefore, columnar spacers can adequately be intervened between both substrates 1 and 2 in the sealant outer region 6. Even this modification can make it difficult to produce a non-uniform substrate gap in the sealant inner neighborhood region 5, eventually making it possible to set the substrate gap in the entire inward region of the sealant 3 more uniform.

The distribution density of the columnar spacers laid out in the entire inward region of the sealant 3 (i.e., in the sealant inner center region 4 and the sealant inner neighborhood region 5) may be made uniform, and the distribution density of the columnar spacers laid out in the sealant outer region 6 may be set adequately higher than the distribution density of the columnar spacers in the entire inward region of the sealant 3. Even this modification can make it production of a non-uniform substrate gap in the sealant inner neighborhood region 5 difficult, and can set the substrate gap in the entire inward region of the sealant 3 more uniform.

In this case, the distribution density of the columnar spacers laid out in the entire inward region of the sealant 3 is uniform, so that given that one columnar spacer 10 is laid out for one pixel electrode 7, as shown in FIG. 2, for example, it is unnecessary to provide the cutaway portion 9 at the upper left corner of the pixel electrode 7, thus making it possible to improve the aperture ratio accordingly. Apparently, the shapes of the cutaway portions are not limited to the shapes at the upper left corner and the lower left corner of the pixel electrode 7, and the positions and the quantity of the cutaway portions can be adequately changed, as needed, according to the distribution density of the columnar spacers.

The distribution position of the columnar spacer is not limited to the position where the pixel electrode is cut away, but may be any adequate position around the pixel electrode. The shape of the columnar spacer is not limited to a circular shape in cross section, but may be a square shape in cross section, an octagonal shape in cross section, a rectangular shape in cross section, an elliptical shape in cross section or the like. Further, the liquid crystal display apparatus is not limited to the embodiment, but may have thin film diodes as the switching elements, or may be of a simple or passive matrix type.

According to the invention, as described above, the distribution density of the columnar spacers in the inner neighborhood of the sealant is set higher than the distribution density of the columnar spacers in a region inward of the inner neighborhood of the sealant. When the sealant is cured by pressure and heating, therefore, the pressure applied to each of the columnar spacers laid out in the inner neighborhood of the sealant becomes approximately equal to the pressure applied to each of the columnar spacers laid out in the region inward of the inner neighborhood of the sealant, so that the columnar spacers laid out in the inner neighborhood of the sealant are crushed in approximately the same way as the columnar spacers laid out in the region inward of the inner neighborhood of the sealant. As a result, it becomes difficult to produce a non-uniform substrate gap in the inner neighborhood of the sealant, thus making it possible to provide a liquid crystal display apparatus with a highly uniform substrate gap.

Various embodiments and changes may be made thereunto without departing from the broad spirit and scope of the invention. The above-described embodiment is intended to illustrate the present invention, not to limit the scope of the present invention. The scope of the present invention is shown by the attached claims rather than the embodiment. Various modifications made within the meaning of an equivalent of the claims of the invention and within the claims are to be regarded to be in the scope of the present invention.

This application is based on Japanese Patent Application No. 2004-162761 filed on Jun. 1, 2004 and including specification, claims, drawings and summary. The disclosure of the above Japanese Patent Application is incorporated herein by reference in its entirety.

1. A liquid crystal display apparatus comprising:
a first substrate;
a second substrate facing the first substrate;
a sealant provided between the first substrate and the second substrate;
a liquid crystal filled in space formed by the first substrate, the second substrate and the sealant; and
columnar spacers provided between the first substrate and the second substrate, inward of the sealant,
whereby a distribution density of those columnar spacers which are located in a inner neighborhood of the sealant is higher than a distribution density of those columnar spacers which are located in a inner center of the sealant.

2. The liquid crystal display apparatus according to claim 1, wherein columnar spacers are provided between both of the substrates outward of the sealant at a distribution density nearly equal to the distribution density of the columnar spacers in the inner neighborhood of the sealant.

3. The liquid crystal display apparatus according to claim 1, wherein no columnar spacers are provided in a region where the sealant to bond both of the substrates is formed.

4. The liquid crystal display apparatus according to claim 1, wherein the first substrate is an active substrate having pixel electrodes laid out in a matrix form, and the second substrate is an opposing substrate where an opposing electrode facing the pixel electrodes is provided.

5. The liquid crystal display apparatus according to claim 4, wherein the columnar spacers are provided between both of the substrates where the pixel electrodes are not formed.

6. The liquid crystal display apparatus according to claim 1, wherein the distribution density of the columnar spacers in the inner neighborhood of the sealant is more than one columnar spacer per pixel.

7. The liquid crystal display apparatus according to claim 1, wherein the distribution density of the columnar spacers at a region of the inner center of the sealant is one columnar spacer per pixel.

8. The liquid crystal display apparatus according to claim 1, wherein columnar spacers are provided between both of the substrates outward of the sealant, and a distribution density of the columnar spacers outward of the sealant is higher than the distribution density of those columnar spacers which are provided in the inner center of the sealant.

9. A liquid crystal display apparatus comprising:
a first substrate;
a second substrate facing the first substrate;
a sealant provided between the first substrate and the second substrate;
a liquid crystal filled in space formed by the first substrate, the second substrate and the sealant; and
columnar spacers provided between the first substrate inward and outward of the sealant and the second substrate,
whereby a distribution density of the columnar spacers provided inward of the sealant is substantially identical over an entire region, and
a distribution density of the columnar spacers provided outward of the sealant is higher than the distribution density of the columnar spacers provided inward of the sealant.

10. A liquid crystal display apparatus comprising:
an active substrate having switching elements formed on one side of the active substrate, pixel electrodes connected to the switching elements, and an alignment film which covers the pixel electrodes and the one side of the active substrate;
an opposing substrate having an opposing electrode formed on one side of the opposing substrate and facing the pixel electrodes, and an alignment film which covers the opposing electrode;
a sealant provided between the active substrate and the opposing substrate;
a liquid crystal filled in space formed by the active substrate, the opposing substrate and the sealant; and
columnar spacers provided between the alignment film formed on the one side of the active substrate and the alignment film formed on the one side of the opposing substrate, inward of the sealant, and being in close contact with both of the alignment films,
whereby a distribution density of those columnar spacers which are located in a neighborhood of the sealant is higher than a distribution density of those columnar spacers which are located inward of the sealant.

11. The liquid crystal display apparatus according to claim 10, wherein columnar spacers are provided between both of the substrates outward of the sealant at a distribution density nearly equal to the distribution density of the columnar spacers in the neighborhood of the sealant.

12. The liquid crystal display apparatus according to claim 10, wherein the distribution density of the columnar spacers provided between both of the substrates outward of the sealant is higher than the distribution density of those columnar spacers which are provided between both of the substrates inward of the sealant.

13. A liquid crystal display apparatus comprising:
an active substrate having switching elements formed on one side of the active substrate, pixel electrodes connected to the switching elements, and an alignment film which covers the pixel electrodes and the one side of the active substrate;
an opposing substrate having an opposing electrode formed on one side of the opposing substrate and facing the pixel electrodes, and an alignment film which covers the opposing electrode;
a sealant provided between the active substrate and the opposing substrate;
a liquid crystal filled in space formed by the active substrate, the opposing substrate and the sealant; and
columnar spacers provided between the alignment film provided at the active substrate inward and outward of the sealant, and the alignment film provided at the opposing substrate, in close contact with both of the alignment films,
whereby a distribution density of the columnar spacers in an inward region of the sealant is substantially identical over an entire region, and
a distribution density of the columnar spacers in an outward region of the sealant is higher than the distribution density of the columnar spacers in the inward region.
